(19) United States
(12) Patent Application Publication
(10) Pub. No.: US 2018/0144597 A1
(43) Pub. Date: May 24, 2018

(54) SMART SENSOR AND METHOD USING THE SAME

(71) Applicants: Inventec (Pudong) Technology Corporation, Shanghai (CN); INVENTEC CORPORATION, Taipei City (TW)

(72) Inventors: Ping-Hsu CHU, TAIPEI CITY (TW); Chun-Chieh CHEN, TAIPEI CITY (TW); Sheng-Yuan WU, TAIPEI CITY (TW); Hsiang-Hua FANG, TAIPEI CITY (TW); Ting-Yi WANG, TAIPEI CITY (TW)

(21) Appl. No.: 15/401,109

(22) Filed: Jan. 9, 2017

(30) Foreign Application Priority Data
Nov. 22, 2016 (CN) 201611041037.4

(51) Int. Cl. G08B 21/02

(52) U.S. Cl. CPC G08B 21/02; G08G 1/005

(57) ABSTRACT

The present disclosure provides a smart sensor. The smart sensor includes at least one sensing module, a positioning module, a memory, a processor, and an alerting module connected to each other. The sensing module is configured to record a relative distance and a relative velocity between a user and people, or between the user and objects. The positioning module is configured to record a position signal of the user, and calculating the self-velocity of the user through the position signal. The memory is configured to store the relative distance, the relative velocity, the self-velocity, and a judging method. The processor determines whether the user is in a dangerous position based on the relative distance, the relative velocity, the self-velocity, and the judging method.

### CROSS-REFERENCE TO RELATED APPLICATION

This application claims priority to Chinese Application Serial Number 201611041037.4, filed Nov. 22, 2016, which is herein incorporated by reference.

### BACKGROUND

### Field of Invention

The present invention relates to a sensor and method using the same; more particularly, the present invention relates to a smart sensor and method using the same for judging whether a user is safe.

### Description of Related Art

As society develops, science and technology continue to progress, and security problems increase as pedestrians walk upon the road. For example, today, it is typical for people to wear headphones with complete ear cover when walking on the road, but these type of headphones reduce the pedestrian's sensitivity to the their surroundings, so as to cause danger easily because of a possible moment of negligence. On the other hand, considering the development of traffic, when riding vehicles, such as locomotives, on the road, riders may be oblivious to the surrounding potential risks because of the same poor sensitivity.

The visual corners and visual shortcomings are typically located on both sides of the eyes, behind, and in front as well, so it is important to be careful. Today, although similar devices have been developed, such as reversing radar, these are typically configured only upon transports, and generally, only in the rear. It is not enough to remind users when they are surrounded by objects or a human body is approaching.

Thus, it is the topic with the most attention and desiring a solution for how to provide a device that can proactively acknowledge the relative distance relationship between pedestrians and objects, such as the relative distance being too close or the relative velocity being too high, to alert the pedestrians to make a corresponding avoidance action, and so as to enhance the safety of the pedestrians.

### SUMMARY

The present disclosure provides a smart sensor. The smart sensor comprises at least one sensing module, a positioning module, a memory, a processor, and an alerting module. The at least one sensing module is configured to record a relative distance and a relative velocity between a user and people, or between the user and objects. The positioning module is electrically connected to the at least one sensing module, and configured to record a position signal of the user, and calculate a self-velocity of the user through the position signal. The memory is electrically connected to the positioning module, and configured to store the relative distance, the relative velocity, the self-velocity, and a judging method. The processor is electrically connected to the memory and configured to determine whether the user is in a dangerous position based on the relative distance, the relative velocity, the self-velocity, and the judging method. The alerting module is electrically connected to the processor and configured to send a warning signal.

In an embodiment of the disclosure, the mentioned-above at least one sensing module comprises an ultrasonic sensor, an infrared sensor, or combination thereof.

In an embodiment of the disclosure, the mentioned-above position signal of the positioning module is obtained through a built-in global positioning system.

In an embodiment of the disclosure, the mentioned-above position signal of the positioning module is obtained through an external satellite positioning device.

In an embodiment of the disclosure, the mentioned-above alerting module comprises a vibrator unit, a display unit, an audio unit, or combinations thereof.

In an embodiment of the disclosure, the mentioned-above smart sensor further comprises a casing. The casing has a plurality of surfaces, wherein the at least one sensing module is disposed on at least one of the surfaces of the casing.

The present disclosure provides a method of using a smart sensor comprising the following steps. At least one relative distance and at least one relative velocity between a user and people, or between the user and objects through a sensing module are recorded. A self-velocity of the user through a positioning module is recorded. Whether the user is in a dangerous position is determined based on the at least one relative distance, the at least one relative velocity, the self-velocity through a processor. A warning signal is sent through an alerting module when it is judged that the user is in the dangerous position.

In an embodiment of the disclosure, the mentioned-above sensing module records the at least one relative distance and the at least one relative velocity through an ultrasonic sensor or an infrared sensor.

In an embodiment of the disclosure, the mentioned-above positioning module records the self-velocity of the user through calculating a position signal of the user, wherein the position signal is from a built-in global positioning system or an external satellite positioning device.

In an embodiment of the disclosure, the mentioned-above warning signal of the alerting module is sent through a vibrator unit, a display unit, an audio unit, or combinations thereof.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read in association with the accompanying figures. It is noted that, in accordance with the standard practice in the industry, various features in drawings are not drawn to scale. In fact, the dimensions of illustrated features may be arbitrarily increased or decreased for clarity of discussion.

FIG. 1 is a block diagram of a smart sensor according to some embodiments of the disclosure;

FIG. 2 is a block diagram of a sensing module of a smart sensor according to some embodiments of the disclosure;

FIG. 3 is a block diagram of an alerting module of a smart sensor according to some embodiments of the disclosure;

FIG. 4 is a flow chart of a using method of a smart sensor according to some embodiments of the disclosure;

FIG. 5A is a schematic view of a smart sensor according to some embodiments of the disclosure;

FIG. 5B is a chart of a judging method of a smart sensor according to some embodiments of the disclosure;

FIG. 6A is a schematic view of a smart sensor according to some embodiments of the disclosure; and

FIG. 6B is a chart of a judging method of a smart sensor according to some embodiments of the disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

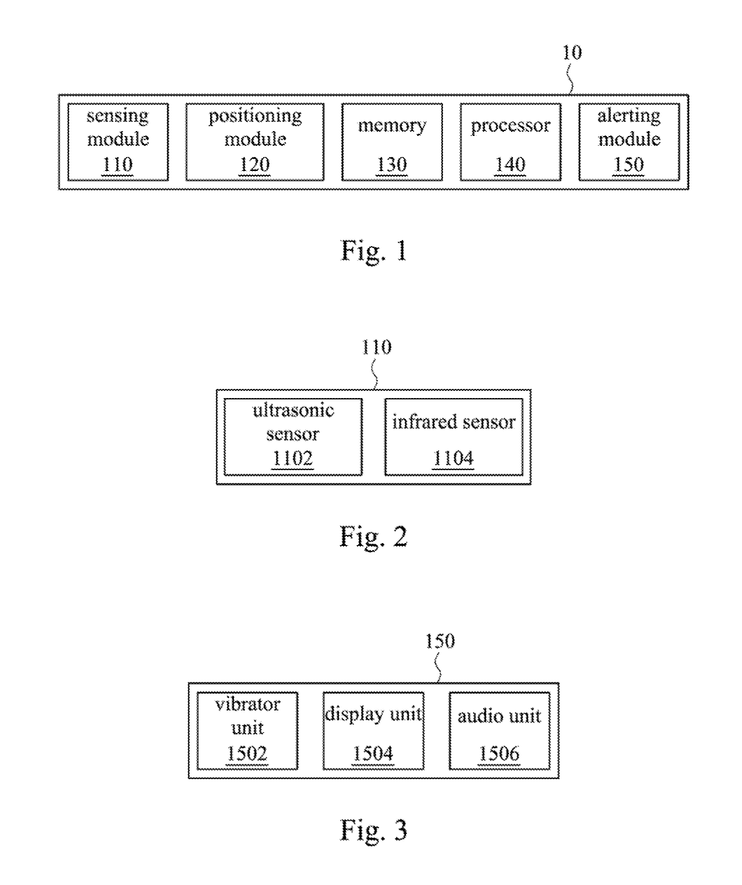

FIG. 1 is a block diagram of a smart sensor according to some embodiments of the disclosure. FIG. 2 is a block diagram of a sensing module of a smart sensor according to some embodiments of the disclosure. FIG. 3 is a block diagram of an alerting module of a smart sensor according to some embodiments of the disclosure. A smart sensor 10 comprises a sensing module 110, a positioning module 120, a memory 130, a processor 140, and an alerting module 150. Each of the above is electrically connected to each other to provide electrical signal and data transmission.

In addition, the smart sensor 10 further comprises a power module (not shown). In some embodiments, for example, the power module may be a replaceable battery, a rechargeable battery, a solar cell, or the like, used for as a power source for the smart sensor 10.

Referring to FIG. 1 and FIG. 2, the sensing module 110 of the smart sensor 10 is configured to record a relative distance and a relative velocity between a user and people, or between the user and objects. As shown in FIG. 2, the sensing module 110 comprises an ultrasonic sensor and an infrared sensor. However, the present disclosure should not be limited herein; sensing module 110 can be designed with other sensing devices in practical applications. The ultrasonic sensor 1102 of the sensing module 110 consists of an ultrasonic transmitter, an ultrasonic receiver, and a control circuit.

The ultrasonic sensor 1102 sends high-frequency sound waves by the ultrasonic transmitter, and reflected waves generated after the sound waves hit the object is received by an ultrasonic receiver of the ultrasonic sensor 1102. Then, the time from emission to reception of the sound waves is measured through the control circuit, and the relative distance between user and objects is calculated according to the formula preset of the ultrasonic sensor 1102 inside. In addition, the relative velocity between the user and the object can be further calculated through the variation of the relative distance between the user and the objects. It should be understood that, the above-described methods are only one aspect of the present disclosure and are not intended to limit the present disclosure.

On the other hand, the infrared sensor 1104 of the sensor module 110 can be used to sense the relative distance and relative velocity between user and objects. The principle of its operation is similar to the ultrasonic sensor 1102 described above; it will be omitted and not repeated herein. Besides, the infrared sensor 1104 may further be used to sense thermal energy, particularly for radiation from human body at the body temperature. Therefore, the purpose of the sensing module 110 with both ultrasonic sensor 1102 and infrared sensor 1104 is not only for being a dual sensor such that the accuracy of the relative distance and the relative velocity between the user and the objects could be higher, but also for further determining whether the object or the human body is close to the user through the infrared sensor 1104.

Referring to FIG. 1 again, the positioning module 120 of the smart sensor 10 is configured to record a self-velocity of the user. In some embodiments, the positioning module 120 calculates the self-velocity of the user by detecting a position signal of the user and according to the amount of change in the distance within a certain time period. Therefore, the sensing module 110 is configured to sense the relative distance or relative velocity between the user and another object (object or body), and the positioning module 120 is configured to sense the self-velocity of the user.

In some embodiments, the positioning module 120 is provided with a global positioning system (GPS), which can directly measure the position signal and the self-velocity of the user in the smart sensor 10. In some other embodiments, the position signal of the positioning module 120 may be from other external satellite positioning devices, such as a satellite positioning system within a cellphone or other device equipped with a satellite positioning system. If the position signal of the positioning module 120 is from other devices, the positioning module 120 is provided with a wireless communication system internally so as to transmit signals and data with other external devices. For example, the wireless communication system can be bluetooth, infrared, wifi, near field communication (NFC) and so on.

The memory 130 of the smart sensor 10 is configured to store various settings of the smart sensor 10. For example, the memory 130 can be configured to store the relative velocity or relative distance between the user and external object (body or object) measured by the sensing module 110 and the self-velocity calculated by the positioning module 120, and so on. In the present embodiment, the memory 130 is further configured to store the judging method of the smart sensor 10 to be discussed later.

The processor 140 of the smart sensor 10 is configured to integrate the signal and data of the smart sensor 10 and calculate. For example, there is a signal conversion engine in the processor 140. The signal conversion engine can convert the signal stored in other modules (such as sensing module 110, positioning module 120, or memory 130) to a calculable form. In addition, processor 140 can be configured to calculate the judging method of the smart sensor 10 to be discussed later.

The alerting module 150 of the smart sensor 10 is configured to inform the state of the user. In some embodiments, for example, when the user's self-velocity recorded by the positioning module 120 is higher than a certain critical value, the alerting module 150 may inform the user that it is in a dangerous position, thereby driving the user to slow down the movement or raise vigilance, and so on.

Referring to FIG. 1 and FIG. 3, the alerting module 150 comprises a vibrator unit 1502, a display unit 1504, an audio unit 1506, and the like. The vibrator unit 1502, for example, can be a vibration motor. The display unit 1504 may be a liquid crystal display (LCD) panel, a touch LCD panel, or other display device. The audio unit 1506 can be speakers and so on. Therefore, by installing different units (such as the above-mentioned vibrator unit 1502, display unit 1504 and audio unit 1506) in the smart sensor 10, it can remind the user in which the state in different forms.

In addition, the display unit 1504 further provides an operation interface. The user not only can see the warning message through the display unit 1504, but also can set the smart sensor 10 to perform various functions through the display unit 1504 (for example, touch screen). In some embodiments, for example, the vibrator unit 1502, the display unit 1504, and the audio unit 1506 do not need to operate simultaneously to present an alert message to the user. The user can turn off alert messages of the vibrator unit 1502 and the display unit 1504 in the setup menu, and be obtained the alert message merely by the sound emitted from the audio unit 1506. In other some embodiments, it is also possible to turn off the alert message of the audio unit 1506 and to turn on the alert message of the other unit. A variety of settings can be stored in the memory 130 of the smart sensor 10. Of course, the above-described embodiments are only one aspect of the present disclosure and are not intended to limit the present disclosure.

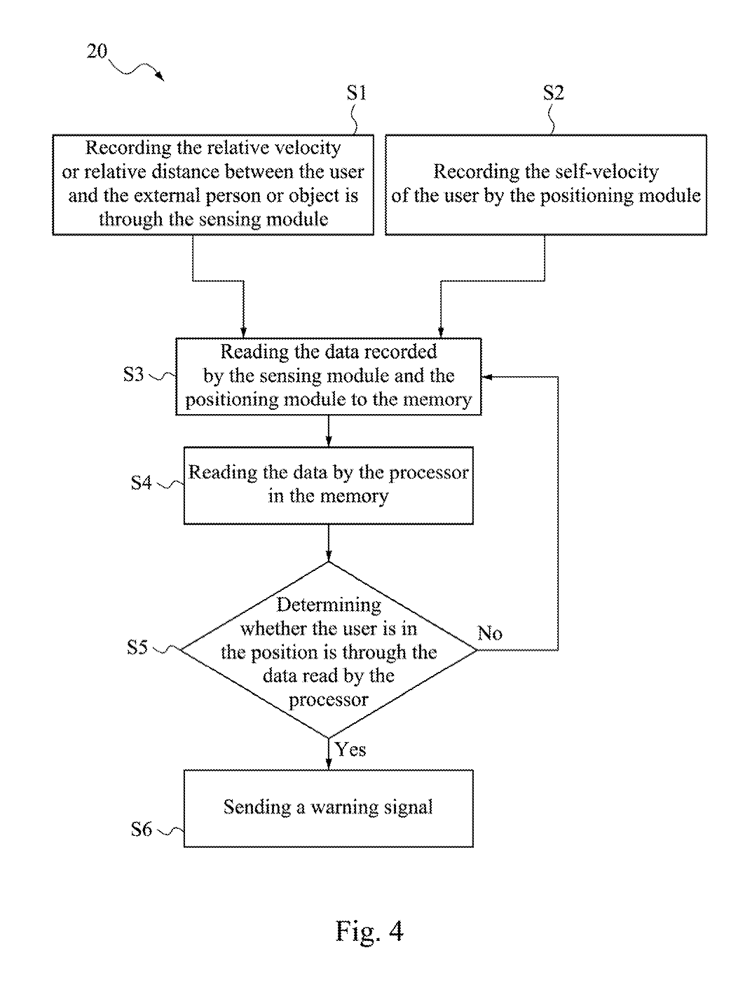

FIG. 4 is a flow chart of a using method of a smart sensor according to some embodiments of the disclosure. Method 20 starts at step S1 and step S2. In step S1, the relative velocity or relative distance between the user and the external person or object is recorded through the sensing module. As mentioned above, the sensor module can have an ultrasonic sensor and an infrared sensor. The relative distance and the relative velocity between the user and the surrounding people or objects can be sensed by the time difference between the transmitted wave (ultrasonic wave or infrared ray) and the reflected wave. In addition, it can be further configured to determine whether the object around the user is the human body or not through the thermal sensing of the infrared sensor.

In step S2, the self-velocity of the user is recorded by the positioning module. As mentioned above, the self-velocity of the user is determined by calculating the change in the position of the position of the user for a fixed period of time. In addition, the user's positioning information can be obtained through the global positioning system in the positioning module. It is also possible to obtain the user's positioning information from another device (such as a mobile phone or other satellite positioning device) through a wireless communication system.

In step S3, the data recorded by the sensing module and the positioning module is read to the memory. In detail, step S3 is to read the relative velocity or the relative distance between the user and the external people or objects and the user's self-velocity measured by step S1 and step S2 to the memory.

In step S4, the processor reads the data in the memory. The data read by the processor referred herein may comprise the relative velocity or the relative distance between the user and the external people or objects and the user's self-velocity recorded by step S1 and step S2. In addition, the processor also reads a judging method (as discussed in detail in the following) preset by the user in the memory so as to do the corresponding calculating in the subsequent steps.

In step S5, whether the user is in the position is determined through the data read by the processor. In some embodiments, for example, the user sets that a dangerous position is determined when the self-velocity exceeds a critical value. When the processor read the user's current self-velocity greater than the critical value from the memory, then a dangerous position is determined.

If it is judged that the user is in the dangerous position in step S5, the process proceeds to step S6, and a warning signal is send. As mentioned above, the warning signal can be alerted through the vibrator unit, the display unit, or the audio unit within the alerting module in the smart sensor. In some embodiments, for example, the user can be simultaneously informed that the user is in a dangerous position by a vibration, displaying a warning label on the liquid crystal display, and emitting a sound, so as to drive the user to raise vigilance to avoid danger.

If it is judged that the user is not in the dangerous position in step S5, repeat step S3 and continue to read data recorded by sensing module and positioning module to the memory to continue the subsequent judgment.

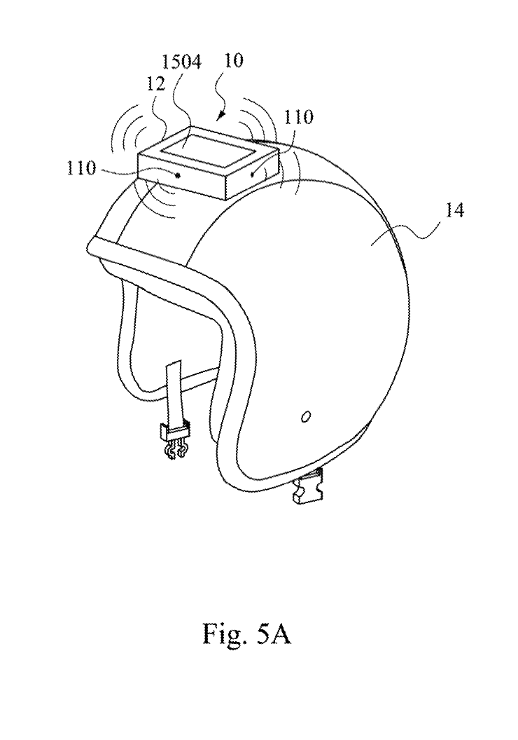

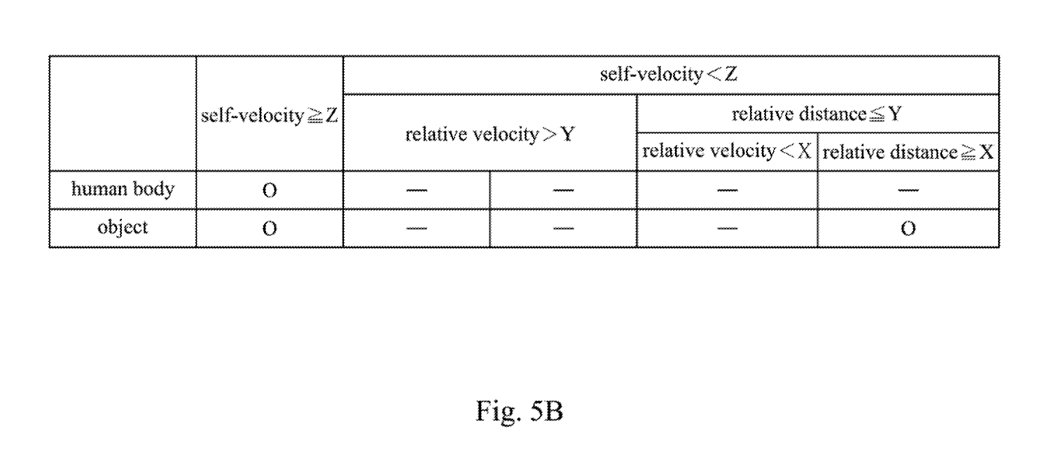

FIG. 5A is a schematic view of a smart sensor according to some embodiments of the disclosure. In the present embodiment, the smart sensor 10 has a casing 12, and the casing 12 is a cuboid having six surfaces. The smart sensor 10 is detachably disposed on a head-mounted display 14, such as a motorcycle helmet or a bicycle helmet. In some embodiments, the smart sensor 10 may be configured on other devices, such as a rear seat of a bicycle, a bag of a user, or any other possible location.

Furthermore, the display unit 1504 is configured on one surface of the smart sensors 10. In the present embodiment, the display unit 1504 is a touch panel, and is provided as a setting interface for a user to configure various settings within the smart sensor 10. In addition, in the present embodiment, since the smart sensor 10 is configured on the head-mounted display 14, the four surfaces of the smart sensor 10 are configured with the sensor modules 110. Thus, when the user is traveling (for example, riding a motorcycle), the smart sensor 10 provides four-directional sensing effects so as to increase the user's security.

In some other embodiments, each surface of the smart sensor 10 (six in the present embodiment) is configured with the sensing module 110, thereby providing omnidirectional sensing effects. The advantage of this configuration is that, since the smart sensor 10 is detachably disposed on the head-mounted display 14, the user can place the smart sensor 10 directly above or elsewhere, such as on a bicycle seat cushion or rear of head-mounted display. The sensing direction of the smart sensor 10 still will not be affected since each surface of the smart sensor 10 is configured with the sensing module 110.

FIG. 5B is a chart of a judging method of a smart sensor according to some embodiments of the disclosure. In the present embodiment, the judging method of FIG. 5B assumes that the user is riding a motorcycle and wearing the smart sensor 10 and the head-mounted display 14 shown in FIG. 5A to ensure the safety of the user traveling on the road.

The judging method of FIG. 5B is preset by the user and stored in the smart sensor of the memory, and it is processing judging through reading the data in the memory by the processor. First, the user pre-set a plurality of critical values in the smart sensor and stored in the memory. The critical values herein include the critical value Z of the self-velocity, the critical value X of the relative velocity between the user and the person or object, and the critical value Y of the relative distance between the user and the person or object. In some embodiments, if the user is riding a motorcycle, it can be set 90 km/hr to the critical value Z of the self-velocity, 60 km/hr to the critical value X of the relative velocity between the user and the person or object, and 30 meters (m) to the critical value Y of the relative distance between the user and the person or object. In some other embodiments, if the user is a pedestrian or riding a motorcycle, it can be set 30 km/hr to the critical value Z of the self-velocity, 60 km/hr to the critical value X of the relative velocity between the user and the person or object, and 20 meters (m) to the critical value Y of the relative distance between the user and the person or object. The critical values are only examples and are not intended to limit the present disclosure.

As mentioned above, the self-velocity of the user is measured through the positioning module of the smart sensor, and the relative velocity and relative distance between the user and the person or object are measured through the sensing module.

The judging method of FIG. 5B first determines whether the self-velocity of the user exceeds the critical value Z or not. If the self-velocity is greater than the critical value Z, a dangerous position is determined. The smart sensor sends a warning signal, and the warning signal can be vibration, screen display, or sound effects.

If the self-velocity of the user is less than the critical value Z, then it represents that the user is at a safe traveling speed. Then the processor continues to determine whether the relative distance between the user and the person or object is greater than the critical value Y or not. If the relative distance between the user and the surrounding person or object is greater than the critical value Y, then it represents that the user is at a safe distance with the surrounding person or object.

As just mentioned, if the processor determines that the relative distance between the user and the surrounding person or object is less than the critical value Y, it represents that the user is at an unsafe distance with the surrounding person or object. Therefore, the processor continues to determine whether the relative velocity between the user and the person or object is less than the critical value X. If the relative velocity between the user and the person or object is less than critical value X, a safe position is determined. However, if the relative velocity between the user and the person or object is greater than critical value X, then it represents that the user is not only at an unsafe distance with the surrounding person or object, but also is close to him at a high speed.

Next, the processor further determines which of a human body or an object is approaching to the user, and it is recognized in this step through the infrared sensor in the sensing module. If some approaching is the human body, it is determined as a safe state. Conversely, if some approaching is an object (such as a large car, etc.), the processor determines if the state is a dangerous position, the smart sensor further send a warning signal to alert the user to be vigilant.

In some other embodiments, the processor may pre-determine which of a human body or an object is approaching to the user, and it has different critical values (e.g., the relative distance, the relative velocity, or the self-velocity) when between the user and human body or between the user and the object. For example, it can be set 10 meters to the critical value of the relative distance between the user and the person since the speed of the human body is relatively slow. And, it can be set 30 meters to the critical value of the relative distance between the user and the object since the speed of the object (such as cars, etc.) is relatively fast.

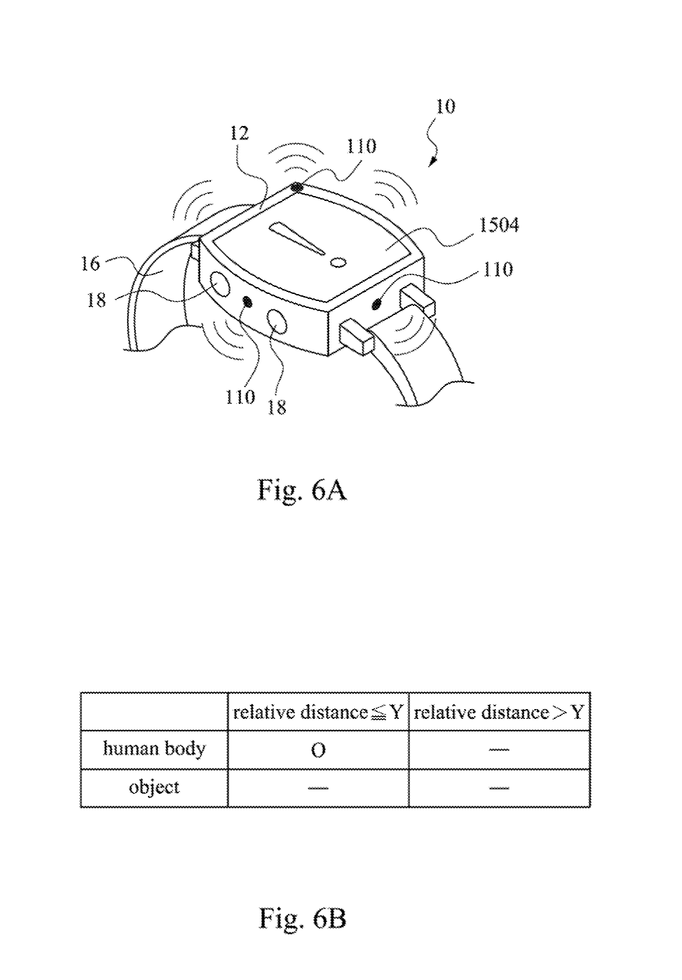

FIG. 6A is a schematic view of a smart sensor according to some embodiments of the disclosure. In the present embodiment, the smart sensor 10 has a casing 12, and the casing 12 is a cuboid having six surfaces. The smart sensor 10 is detachably disposed on a watch strap 16, for the user to wear in or on their hands.

Furthermore, the display unit 1504 is configured on one surface of the smart sensors 10. On the other hand, smart sensors 10 is configured with a plurality of buttons 18. In the present embodiment, the display unit 1504 is a LCD panel, and the user can configure various settings within the smart sensor 10 through the display unit 1504 and the buttons 18. In addition, a plurality of surfaces of the smart sensor 10 is configured with the sensor modules 110, so when the user is walking, the smart sensor 10 provide multi-directional sensing effects so as to increase the user's security.

FIG. 6B is a chart of a judging method of a smart sensor according to some embodiments of the disclosure. In the present embodiment, the judging method of FIG. 6B assumes that the user is wearing the smart sensor 10 and the watch strap 16. For example, the user is wearing smart sensor 10 in the night, and the judging method of FIG. 6B is used to determine whether there is a human body approaching the rear of the user or not.

The judging method of FIG. 6B is preset by the user and stored in the smart sensor of the memory, and it is processing judging through reading the data in the memory by the processor. First, the user pre-sets a critical value Y of the relative distance between the user and the external person or object in the smart sensor. It can be set 20 meters (m) to the critical value Y of the relative distance; however, the present disclosure is not limited herein.

The judging method of FIG. 6B first determines whether the relative distance between the user and the external person or object is greater than the critical value Y or not. As mentioned previously, the relative distance between the user and the person or object is measured through the sensing module. If the relative distance is greater than the critical value Y, then it represents that the user is at a safe state.

If the processor determines that the relative distance is less than the critical value, and then it continues to determine which of a human body or an object is approaching to the user. As mentioned previously, it can further determine whether some approaching the user is the human body or object through the thermal sensing since the sensing module of the smart sensor is configured with the infrared sensor.

If the object is determined, it represents the user is at a safe state. If the human body is determined, the alerting module sends a warning to inform the user to alert the suspect person around. For example, the alerting module can send a warning signal through the display unit (as shown in FIG. 6A), or make a sound through the audio unit to intimidate the surrounding suspect person.

It should be understood that the various methods and embodiments described above are only different embodiments of the present disclosure and are not intended to be limiting of the present disclosure. In the practical application, the user can design the appearance, the location of the configuration of the smart sensor. It can also be designed to the method for judging the dangerous position.

The present disclosure provides a smart sensor. A sensing module of the smart sensor comprising an ultrasonic sensor and an infrared sensor is not only configured to record a relative distance and a relative velocity between a user and people, or between the user and objects, but also to distinguish between the human body and objects, and thus the purpose of multiple sensing is achieved.

A positioning module of the smart sensor is configured to record a position signal of the user, and the position signal of the user can be measured through a built-in global positioning system or by inputting location information from an external satellite positioning device.

An alerting module of the smart sensor comprising a vibrator unit, a display unit, and an audio unit may provide the user a variety of alerting ways.

Sensing modules of the smart sensor can be disposed on a plurality of surfaces of the smart sensor to provide multi-directional sensing. In addition, when the direction or angle of the smart sensor configuration changes, an omni-directional sensing still can be maintained because there are sensing modules configured on the plurality of surfaces.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A smart sensor, comprising:
at least one sensing module, configured to record a relative distance and a relative velocity between a user and people, or between the user and objects;
a positioning module, electrically connected to the at least one sensing module, and configured to record a position signal of the user, and calculate a self-velocity of the user through the position signal;
a memory, electrically connected to the positioning module, and configured to store the relative distance, the relative velocity, the self-velocity, and a judging method;
a processor, electrically connected to the memory, and configured to determine whether the user is in a dangerous position based on the relative distance, the relative velocity, the self-velocity, and the judging method; and
an alerting module, electrically connected to the processor, and configured to send a warning signal.

2. The smart sensor of claim 1, wherein the at least one sensing module comprises an ultrasonic sensor, an infrared sensor, or combination thereof.

3. The smart sensor of claim 1, wherein the position signal of the positioning module is obtained through a built-in global positioning system.

4. The smart sensor of claim 1, wherein the position signal of the positioning module is obtained through an external satellite positioning device.

5. The smart sensor of claim 1, wherein the alerting module comprises a vibrator unit, a display unit, an audio unit, or combinations thereof.

6. The smart sensor of claim 1, further comprising:
a casing, having a plurality of surfaces, wherein the at least one sensing module is disposed on at least one of the surfaces of the casing.

7. A method of using a smart sensor, comprising:
recording at least one relative distance and at least one relative velocity between a user and people, or between the user and objects through a sensing module;
recording a self-velocity of the user through a positioning module;
determining whether the user is in a dangerous position based on the at least one relative distance, the at least one relative velocity, the self-velocity through a processor; and
sending a warning signal through an alerting module when it is judged that the user is in the dangerous position.

8. The method of using the smart sensor of claim 7, wherein:
the sensing module records the at least one relative distance and the at least one relative velocity through an ultrasonic sensor or an infrared sensor.

9. The method of using the smart sensor of claim 7, wherein:
the positioning module records the self-velocity of the user through calculating a position signal of the user, wherein the position signal is from a built-in global positioning system or an external satellite positioning device.

10. The method of using the smart sensor of claim 7, wherein the warning signal of the alerting module is sent through a vibrator unit, a display unit, an audio unit, or combinations thereof.
